(19) United States
(12) Patent Application Publication
(10) Pub. No.: US 2026/0237254 A1
(43) Pub. Date: Aug. 13, 2026

(54) System for Monitoring, Logging, and Traceability of Operational Data for a Towable Recreational Vehicle

(71) Applicant: Shenzhen Haoyiche Technology Co., Ltd., Shenzhen (CN)

(72) Inventors: Kongchang Xiao, Shenzhen (CN); Qiuhai Chen, Shenzhen (CN); Kongjun Xiao, Shenzhen (CN); Zhihua Jian, Shenzhen (CN)

(21) Appl. No.: 19/638,084

(22) Filed: Apr. 2, 2026

(30) Foreign Application Priority Data
Dec. 29, 2025 (CN) 202512016044.4

(51) Int. Cl. G07C 5/08; G06Q 10/20; G07C 5/00

(52) U.S. Cl. CPC G07C 5/0825; G06Q 10/20; G07C 5/008; G07C 5/0808; G07C 5/085

(57) ABSTRACT

The present invention relates to a safety status monitoring and traceable management system for a travel trailer. The safety status monitoring and traceable management system for a travel trailer collects data such as total driving mileage, maintenance status, vehicle speed, wheel status, hitch weight, temperature and humidity inside and outside the travel trailer, and the travel trailer's level attitude via a sensor module; a data processing center analyzes the data and generates operating logs or abnormal logs, a data storage module stores the logs to achieve full-process monitoring and assist in accident reconstruction, and a user interaction interface displays the current travel trailer status and related alert information to the travel trailer user.

### TECHNICAL FIELD

The present invention relates to the technical field of vehicle safety management, and, more specifically, to a safety status monitoring and traceable management system for a towable recreational vehicle.

### BACKGROUND OF THE INVENTION

A towable recreational vehicle (also called travel trailer) is a special type of recreational vehicle that lacks its own power system and instead connects to a towing vehicle, which provides the necessary towing power. In recent years, with the increasing demand for self-driving tourism and long-distance camping, the usage scenarios for travel trailers have become more diverse, including long-distance driving on highways, as well as driving through mountainous winding roads, unpaved campground roads, and other complex road conditions.

However, the use of travel trailers is characterized by intermittent usage and multiple users. These vehicles may be parked for extended periods before being used again or may frequently change users in rental and sharing scenarios. If there is no continuous record of a travel trailer's operation, usage environment, and changes in key parameters, it becomes difficult to accurately understand the travel trailer's actual stress history, instances of overuse, and exposure to extreme conditions. In existing technologies, some travel trailers rely solely on maintenance manuals, paper-based maintenance records, or simple mileage-and time-based alerts, lacking a systematic, traceable, and regularly updated maintenance record linked to actual operating states. When users fail to perform timely maintenance, overload the towing capacity, engage in prolonged speeding, or use the vehicle in inappropriate road conditions, or when maintenance tasks such as tire replacement or connection inspections are not performed as recommended, such behaviors are often not fully recorded.

As a result, when travel trailer failures, connection failures, or tire damage occur due to improper user usage or inadequate maintenance, there is typically a lack of continuous, objective operational and maintenance data to serve as a basis for dividing responsibility and reconstructing the incident. Manufacturers and users often disagree on whether the travel trailer has been used according to specifications, whether the fault is due to quality issues or user behavior, leading to disputes over responsibility, warranty scope, and compensation. This is especially true in accidents involving personal injury or significant property damage, where the lack of a traceable data record chain leads to high proof costs and prolonged dispute cycles, making it difficult to protect users' legal rights and hindering manufacturers from improving quality and managing risks.

Therefore, there is a clear deficiency in the current monitoring of operational states, warning of abnormal conditions, maintenance records, and responsibility traceability for travel trailers. A system that can monitor key operational states in real-time and manage the operational and maintenance processes with traceability is needed.

### SUMMARY OF THE INVENTION

The present invention provides a safety status monitoring and traceable management system for a travel trailer to address the problems raised in the background section above.

To achieve the above purpose, the present invention adopts the following technical solution.

A safety status monitoring and traceable management system for a travel trailer comprises:
a sensor module, configured to monitor multiple operating parameters of the travel trailer during use, the operating parameters comprising at least one type of parameter related to the following items: total mileage, maintenance status, vehicle speed, wheel status, the weight of the hitch, temperature and humidity inside and outside the travel trailer, and the travel trailer's level attitude; and a data processing center, which is in signal communication with the sensor module and in which safety-use specification thresholds corresponding to the operating parameters are pre-stored. The data processing center is configured to: receive the operating parameters collected by the sensor module during operation of the travel trailer; analyze the operating parameters in real time or periodically based on the safety-use specification thresholds to determine whether there is any non-compliant usage behavior or operational abnormality; and, when no non-compliant usage behavior or operational abnormality is determined, generate an operating log record. A data storage module is connected to the data processing center and is configured to store the operating log records as well as the log records with abnormality labels and the abnormal event records, where the log information is used, when an accident occurs, a failure arises, or a dispute needs to be resolved, to assist in accident reconstruction, including assisting in reconstructing the operating states related to the accident, locating abnormal triggering processes, tracing fault causes, determining responsibility, and analyzing user behavior.

In one preferred implementation, the sensor module comprises: a GPS module, configured to detect data such as the travel trailer's driving speed, driving mileage, date, and time; tire pressure and temperature sensors, respectively mounted on each wheel and configured to detect in real time the tire pressure and tire temperature of each wheel; temperature and humidity sensors, respectively disposed inside and outside the travel trailer and configured to detect the temperature and humidity inside and outside the travel trailer and, on this basis, determine the usage environment of interior and exterior facilities; and a level attitude sensor, disposed on the travel trailer and configured to detect the pitch angle and roll angle of the travel trailer relative to the horizontal plane so as to monitor the level attitude of the travel trailer during parking.

In one preferred implementation, the sensor module comprises: a GPS module, configured to detect data such as the travel trailer's driving speed, driving mileage, date, and time; tire pressure and temperature sensors, respectively mounted on each wheel and configured to detect in real time the tire pressure and tire temperature of each wheel; temperature and humidity sensors, respectively disposed inside and outside the travel trailer and configured to detect the temperature and humidity inside and outside the travel trailer and, on this basis, determine the usage environment of interior and exterior facilities; and a level attitude sensor, disposed on the travel trailer and configured to detect the pitch angle and roll angle of the travel trailer relative to the horizontal plane so as to monitor the level attitude of the travel trailer during parking.

In a further implementation, the sensor module further comprises a tongue weight scale, configured to detect the weight of the hitch and operated independently by a user, the tongue weight scale being in wired or wireless communication with the data processing center. After completing a weighing operation, the tongue weight scale uploads the detected tongue weight data to the data processing center.

In a further implementation, the data processing center is further configured, on the basis of receiving data collected by the respective sensor modules, to introduce a three-section recording scheme divided by usage stages, whereby the usage process of the travel trailer is divided into a pre-departure recording section, an in-transit recording section, and a post-decoupling or parking recording section. In the pre-departure recording section, when it is detected that electrical power from a towing vehicle is connected through a trailer plug and the vehicle speed is zero, the system collects date, time, current mileage, maintenance status, hitch weighing data provided by the tongue weight scale, and tire pressure of each tire, and generates a pre-departure log record. In the in-transit recording section, when it is detected that the vehicle speed reaches or exceeds a preset speed-limit threshold, the system records the date and time corresponding to the overspeed event as well as the vehicle speed data at the time of overspeed. In the post-decoupling or parking recording section, the system records the parking-environment temperature and humidity of the travel trailer based on indoor and outdoor temperature and humidity sensors using periodic sampling or threshold-triggered sampling, and records the level attitude of the travel trailer based on the level attitude sensor, and generates a parking log using the collected data.

In a further implementation, the data processing center includes an engineering mode with restricted access, and only personnel authorized by the manufacturer can enter the engineering mode to set system parameters after passing identity authentication.

In a further implementation, the engineering mode is configured such that, after personnel authorized by the manufacturer pass identity authentication and enter the engineering mode, the data processing center receives a maintenance reset command through a setting interface and resets maintenance-threshold counters so that the cumulative driving mileage and cumulative service time start counting again from the reset time, thereby clearing any previously triggered maintenance reminders, and updates the remaining mileage to maintenance and remaining time to maintenance based on a preset mileage threshold and a preset time threshold for maintenance.

In a further implementation, the data processing center is further configured to perform a maintenance management function, comprising: cumulatively counting the driving mileage of the travel trailer based on operating parameters related to vehicle speed or mileage information of the travel trailer; cumulatively counting the service time of the travel trailer based on time information; and, when the cumulative driving mileage reaches a preset mileage threshold for maintenance, or when the cumulative service time reaches a preset time threshold for maintenance, or when both the cumulative driving mileage and the cumulative service time reach their respective preset thresholds, providing a reminder to a user of the travel trailer through a user interface. If, after a maintenance reminder for the travel trailer has been triggered, maintenance is not performed in a timely manner and a potential safety hazard may thus exist for the travel trailer, the data processing center, before each use of the travel trailer, records an “unmaintained abnormal use of the travel trailer” label and stores this label in the data storage module as data support for subsequent accident analysis, fault tracing, responsibility determination, and user behavior analysis. The maintenance reminder records are stored in the data storage module as part of the operating log records, as separate maintenance event records, or simultaneously in both of these forms.

In a further implementation, the data storage module uses one or more of NAND flash memory, a solid-state drive, and an in-vehicle memory chip as local storage.

In a further implementation, the system further comprises a human-machine interaction module, which comprises at least one of a display, an indicator light, a buzzer, and a button, and the data processing center is configured to visually present to a user key operating parameters such as vehicle speed, tire pressure and tire temperature, the weight of the hitch, and temperature and humidity inside and outside the travel trailer via the human-machine interaction module.

In a further implementation, the system further comprises a dual-power automatic switching system, which comprises: a power input module, configured to receive electrical power from a towing vehicle and from the travel trailer itself; a power detection module, configured to obtain voltage and current detection signals from a power input terminal of the towing vehicle and from a power input terminal of the travel trailer itself, and to obtain a conduction-state feedback signal of a power-switching circuit so as to detect the power source used to start the data processing center and to continually determine, during system operation, which power path is currently supplying power to the data processing center, the power-source information output by the power detection module being used as a basis for the data processing center to perform data recording; and an intelligent switching control logic, configured to automatically switch system power supply to the towing vehicle power as a preferred power source when it is detected that power from the towing vehicle is connected, and to automatically perform seamless switching of system power supply to the travel trailer's own power when it is detected that the towing vehicle power is unplugged, interrupted, or abnormal in voltage, so as to ensure continuous operation of the data processing center and the data storage module and thereby maintain continuity of data recording. The intelligent switching control logic is configured such that, when normal connection of power from the towing vehicle is detected, power from the towing vehicle is preferentially used to supply the system and, on this basis, the system determines that the travel trailer is in a pre-departure or in-transit stage; and when no connection of power from the towing vehicle is detected or the towing vehicle power is disconnected, the system automatically switches to power supply from the travel trailer itself and, on this basis, determines that the travel trailer is in a post-decoupling or parking stage.

Compared with the prior art, the invention provides the following beneficial effects. By sensing key parameters such as hitch weight, tire pressure, maintenance status, and temperature and humidity through multiple sensors, and by continuously, normatively, and systematically recording the related data, the system forms an objective and complete operating data chain, thereby providing reliable data evidence for subsequent accident analysis, fault tracing, and responsibility determination.

### BRIEF DESCRIPTION OF THE DRAWINGS

FIG. 1 is a system block diagram of an embodiment of the safety status monitoring and traceable management system for a travel trailer according to the present invention.

FIG. 2 is a processing framework diagram of a data processing center shown in FIG. 1.

FIG. 3 is an interface display diagram of a human-machine interaction module according to the present invention.

In the drawings: 110—Sensor Module; 111—GPS Module; 112—Tire pressure and temperature sensor(s); 113—Temperature and humidity sensor(s) 115—Tongue weight scale; 116—Various Operating Data; 120—Data Processing Center; 130—Data Storage Module; 131—Operation Log Transmission; 140—Human-Machine Interaction Module; 141—Display Screen; 142—Indicator Light; 143—Buzzer; 144—Button(s); 145—User View Logs; 201—Receive various operation data; 202—Compare various data with each preset safety threshold; 203—Determine whether the data is abnormal and generate operation log; 204—Generate normal operation log and send it to data storage module; 205—While generating the log, label and process the corresponding abnormal or rule-breaking data and send it to data storage module.

### DETAILED DESCRIPTION OF THE INVENTION

The technical solutions of the embodiments of the present invention will now be clearly and completely described below with reference to the drawings of the embodiments of the present invention. It is obvious that the described embodiments are merely some rather than all of the embodiments of the present invention. The following descriptions of at least one exemplary embodiment are actually illustrative only and are not intended to impose any limitation whatsoever on the present invention or its applications or uses. All other embodiments that are obtained by persons of ordinary skill in the art based on the embodiments of the present invention without creative effort shall fall within the protection scope of the present invention.

It should be noted that the terms used herein are for the purpose of describing particular embodiments only and are not intended to limit the exemplary embodiments according to the present application. As used herein, unless the context clearly dictates otherwise, the singular forms are also intended to include the plural forms. Furthermore, it should also be understood that when the terms “comprises” and/or “comprising” are used in this specification, they indicate the presence of stated features, steps, operations, devices, components, and/or combinations thereof.

Unless specifically stated otherwise, the relative arrangement of components and steps set forth in these embodiments, numerical expressions, and values do not limit the scope of the present invention. At the same time, it should be understood that, for ease of description, the sizes of the various parts shown in the drawings are not drawn to scale. Techniques, methods, and equipment known to those of ordinary skill in the relevant art may not be discussed in detail, but where appropriate, such techniques, methods, and equipment should be considered as part of the authorized specification. In all examples shown and discussed herein, any specific values should be construed as merely exemplary, rather than as limitations. Accordingly, other examples of the exemplary embodiments may have different values. It should be noted that similar reference numerals and letters refer to similar items in the following drawings, and thus once an item is defined in one drawing, it need not be further discussed in subsequent drawings.

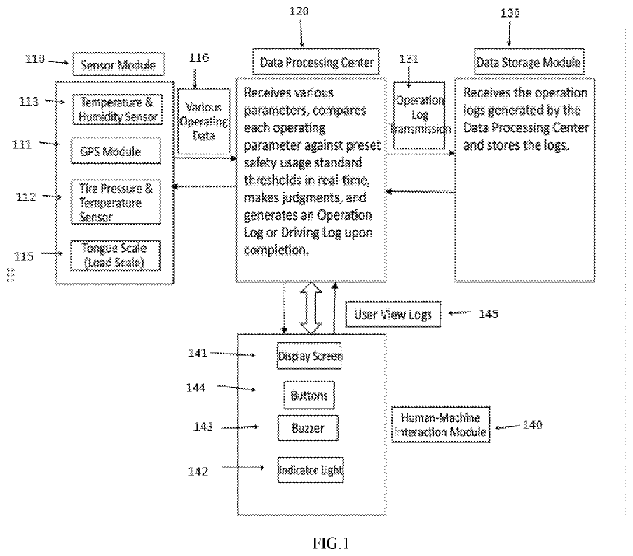

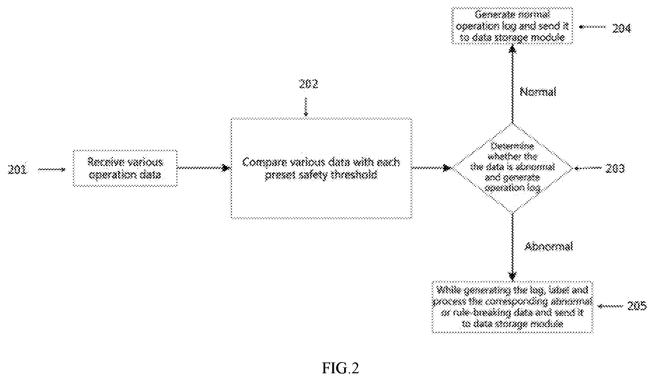

Please refer to FIGS. 1 and 2. The safety status monitoring and traceable management system 110 for a travel trailer provided by the present invention comprises a sensor module 110, a data processing center 120, and a data storage module 130.

In this embodiment, the sensor module 110 comprises
a GPS module 111 configured to detect the travel trailer's driving speed, driving mileage, date, and time data;
tire pressure and temperature sensors 112 respectively mounted on each wheel and configured to detect tire pressure and temperature of each wheel in real time;
temperature and humidity sensors 113 respectively provided inside and outside the travel trailer and configured to detect temperature and humidity inside and outside the travel trailer;
a level attitude sensor provided on the travel trailer and configured to detect pitch angle and roll angle relative to the horizontal plane; and
a tongue weight scale 115 configured to detect hitch weight through separate user operation.

Specifically, the GPS module 111 is configured to acquire positioning and navigation satellite data of the travel trailer (or the towing vehicle) and to output, based thereon, information such as the vehicle's driving speed, driving mileage, date, and time. The GPS module 111 can perform real-time acquisition and updating of speed data and can cumulatively calculate driving mileage based on speed and sampling time intervals, or directly read the mileage output by the GPS module 111. At the same time, the GPS module 111 can also provide standard time information (including date, hour, minute, and second) to serve as the basis for the data processing center 120 to apply time stamps, event sequencing, and tracing to various types of operating data 116.

For example, when the travel trailer is traveling on a highway, the GPS module 111 continuously acquires and updates speed data. When it is detected that the speed exceeds the preset safety speed limit of 120 km/h, the data processing center 120 can compare the acquired speed data and determine that an overspeed condition exists, and accordingly generate an overspeed event log to record the date and time of the overspeed occurrence, the duration of the overspeed, the speed values during the overspeed period, and related operating information.

Geolocation and altitude information is acquired jointly by the GPS positioning module and a barometric altitude sensor. The GPS positioning module is configured to acquire data such as the vehicle's current latitude and longitude coordinates, time information, and ground speed. The barometric altitude sensor is configured to calculate the altitude of the travel trailer based on changes in atmospheric pressure. The data processing center 120 analyzes geolocation and altitude data collected at multiple consecutive time points, calculates the rate of change of position and the rate of change of altitude, and in combination with road smoothness indicators, determines whether the vehicle has entered an unpaved road or complex road conditions. For example, when the altitude and position change dramatically within a unit time and characteristic fluctuations appear in the speed and tire status signals, it can be determined that the current condition is an unpaved road, thereby providing a basis for subsequent safety strategy adjustments.

For example, after the travel trailer has traveled along a section of mountainous road, a GPS positioning module included in the GPS module 111 detects that the vehicle speed gradually decreases while the altitude rises sharply. By analyzing the rates of change of geolocation and altitude, the data processing center 120 determines that the travel trailer may have entered an unpaved road. The system then generates a corresponding log.

Tire pressure and temperature sensor(s) 112 are respectively mounted on each wheel and are configured to monitor the pressure and temperature status of the tires in real time. For example, during a long-distance trip, if one tire of the travel trailer exhibits an excessively high temperature, the tire pressure and temperature sensor(s) 112 detect that the temperature of that tire has exceeded a safety range (for example, above 85° C.). The data processing center 120 compares the detected data in real time and generates an abnormal event log.

Temperature and humidity sensor(s) 113 are provided both inside and outside the travel trailer and are configured to detect temperature and humidity inside and outside the travel trailer. By comprehensively monitoring the temperature difference between the interior and the exterior, their respective absolute temperature values, and humidity levels, it is possible to determine whether the travel trailer is in extreme environments such as high-temperature exposure or severe cold, and to evaluate the operating status of an air-conditioning system, an insulation system, and dehumidification measures inside the travel trailer. Related detection results can be recorded in operating logs and used to evaluate the usage environment and operating conditions of the travel trailer and for subsequent tracing.

For example, when the travel trailer is traveling in or parked outdoors during a hot summer, if the outdoor temperature reaches 40° C. and the interior temperature gradually rises due to prolonged exposure in a sun-scorched area and exceeds a preset safety upper limit, for example 65° C., many unpredictable issues may occur, such as double-sided adhesive tape peeling off, wooden boards cracking, and accelerated aging of various bonded components. Moreover, because solar panels and other equipment may still be operating while the travel trailer is parked, excessively high interior temperatures may adversely affect the performance of internal electronic components. By comparing data from the temperature and humidity sensor(s) 113, when the data processing center 120 detects that the interior temperature is high, it can automatically trigger an air-conditioning system to start in order to adjust the interior temperature and ensure a comfortable interior environment. Likewise, when it is detected that the interior relative humidity remains in a high-humidity range for an extended period, the data processing center 120 can trigger a dehumidification device or a ventilation device to operate so as to reduce interior humidity. It should be noted that long-term high-temperature environments accelerate aging of in-vehicle electrical components and cables and shorten the service life of electrical equipment, while long-term excessive humidity tends to cause corrosion, mildew, debonding, or degradation of thermal insulation performance of the travel trailer's main structure and interior materials, thereby affecting the durability and safety of the travel trailer body. By recording the entire process of temperature and humidity data and corresponding control actions, the present system generates corresponding operating logs and operation logs, which can provide objective evidence, when electrical failures, structural damage, or quality disputes occur, for determining the environmental conditions in which the travel trailer has been located and the effect of such environments on the service life of electrical components and on the service life of the travel trailer body.

A tongue weight scale 115 can be used by a user to detect the weight of a hitch that is used to connect the travel trailer to a towing vehicle.

In this embodiment, the weight of the hitch is defined as the static vertical load at the connection point between the travel trailer and the towing vehicle.

Please refer to FIGS. 1 and 2. In this embodiment, the data processing center 120 is electrically connected to the sensor module 110, incorporates a high-performance microprocessor, and has preset therein various safety-use specification thresholds set by the manufacturer.

When the travel trailer is powered on, the sensors within the sensor module 110 sequentially enter their operating states and begin to detect corresponding operating parameters 116 in real time or periodically. Subsequently, the sensors transmit the collected data to the data processing center 120 via an on-board communication bus or a wireless communication module.

Upon receiving the sensor data described above, the data processing center 120 performs real-time comparison and determination of the various operating parameters against the preset safety-use specification thresholds. When all data are within normal ranges and no non-compliant usage behavior is detected, the data processing center 120 generates a normal operating log. The operating log records information including but not limited to timestamps, vehicle status, key parameter values from each sensor, and corresponding determination results, and stores this log in the data storage module 130 for subsequent operation tracking and data statistical analysis.

For example, when data such as the travel trailer's speed, tire pressure, and hitch weight detection are all within normal ranges, the data processing center 120 generates a “normal operating log” recording the real-time data and determination results from all key sensors. For example, on a certain year, month, day, hour, minute, and second, the speed is 100 km/h and the tire pressure is 2.5 bar. The system stores this information in the data storage module 130 for subsequent tracking and analysis.

When any operating parameter exceeds a preset safety threshold, or when a non-compliant usage behavior is determined based on data trends, the data processing center 120, while generating the log, labels and processes the corresponding abnormal or non-compliant data—for example, by marking the type of violation, the relevant sensor channel, the degree of exceedance, and the duration—and stores this log as an abnormal event log.

For example, when the GPS module 111 of the travel trailer detects that the vehicle speed exceeds a preset safety speed limit (for example, a speed of 120 km/h exceeding the speed limit of 110 km/h), the data processing center 120 compares the data in real time and determines that an overspeed violation has occurred. While generating the abnormal event log, the system labels the violation type (overspeed), the relevant sensor channel (GPS module 111), the degree of overspeed (exceeding by 10 km/h), and the duration (for example, 3 minutes), and stores this log as an abnormal event.

In other embodiments, the data processing center 120 is further configured to perform a vehicle maintenance reminder function. Preset maintenance plan thresholds are stored in the data processing center 120, for example, a cumulative driving mileage of 10,000 km and a vehicle usage time of 365 days. Since the last reset of the maintenance threshold counters, when the vehicle's cumulative driving mileage reaches 10,000 km, or the vehicle usage time reaches 365 days, or both conditions are met simultaneously, the data processing center 120 triggers a maintenance reminder according to preset maintenance rules and outputs corresponding prompt information to the user.

Specifically, the data processing center 120 can perform integral calculations on driving time based on speed data collected by the GPS module 111 so as to cumulatively count the driving mileage of the vehicle; alternatively, the data processing center 120 can directly read the current mileage value provided by an on-board odometer as the cumulative driving mileage. At the same time, the data processing center 120, through a real-time clock module or an on-board time system, continuously counts the continuous usage time of the vehicle since the last reset of the maintenance threshold counters. Each time the mileage data or time data is updated, the data processing center 120 compares the current cumulative driving mileage and usage time against their corresponding maintenance thresholds; when any parameter reaches or exceeds its corresponding maintenance threshold, a maintenance reminder event is generated.

Regarding the reminder method, on one hand, the data processing center 120 can transmit maintenance reminder information to a user terminal through a wireless communication module—for example, by pushing notifications to a companion mobile application or other messaging interface—so that users can receive timely notification of maintenance needs even when they are not near the vehicle. On the other hand, the data processing center 120 can also transmit maintenance reminder instructions to an on-board display screen via a wired connection or an on-board communication bus, with the on-board display screen outputting the maintenance reminder information in the form of icons, text prompts, and/or voice announcements, thereby enabling the driver to intuitively understand the current maintenance status during driving.

For example, when the travel trailer's driving mileage reaches 9,999 km, the data processing center 120 begins tracking the vehicle driving mileage data. When the driving mileage reaches 10,000 km, the system triggers a maintenance reminder according to a preset maintenance cycle, prompts the driver via the on-board display screen to perform routine maintenance, records the maintenance reminder data, and generates a maintenance reminder log for subsequent queries.

It should be noted that, when triggering the maintenance reminder, the data processing center 120 also records, as a maintenance management log, information such as the vehicle driving mileage, vehicle usage time, trigger condition (for example: mileage trigger, time trigger, or simultaneous mileage and time trigger), and reminder output channel at the time the maintenance reminder occurs, and stores this log in the data storage module 130. This maintenance management log can be used for subsequent maintenance record queries, after-sales service management, and vehicle health status assessment. After actual maintenance operations are completed, authorized service personnel or the system can reset the maintenance threshold counters through a setting interface, causing the cumulative statistics of driving mileage and usage time to restart from zero, thereby initiating the next maintenance cycle and saving this maintenance record in the system for subsequent maintenance record queries.

In other embodiments, the data processing center 120 can perform centralized processing of various sensor data collected within a preset data reception time period. Specifically, an engineer can set the start time, end time, and reception time interval parameters for data reception through a host computer or a configuration interface. When the system clock reaches the preset start time, the data processing center 120 begins receiving and buffering real-time data uploaded by the sensors; when the system clock reaches the corresponding end time, it stops the current data reception and performs unified processing on the sensor data buffered within that time period—for example, by executing statistical analysis, abnormality recognition, and operating status determination operations. The engineer can also set a time interval parameter to cause the data processing center 120 to automatically repeat the aforementioned data reception and centralized processing operations at preset intervals.

It should be noted that the data reception start and end times, time interval parameters, and vehicle maintenance intervals are all set by personnel authorized by the manufacturer and access to the relevant setting functions is restricted through an identity authentication mechanism, such that ordinary users cannot directly read or modify these settings and only authorized personnel can operate them. Authorized personnel can enter the engineering mode by entering a preset setting password (for example, “123456”) or by long-pressing a “setting button” 144 for a preset duration (for example, 5 seconds). After manufacturer-authorized personnel pass identity authentication and enter the engineering mode, the data processing center 120 receives a maintenance reset command through a setting interface and resets the maintenance threshold counters, causing the cumulative driving mileage and cumulative usage time to restart counting from the reset moment, thereby clearing any previously triggered maintenance reminder outputs and updating the remaining mileage to maintenance and remaining time to maintenance based on preset maintenance mileage and time thresholds.

To ensure the security and traceability of the system, each time an engineer sets or adjusts data reception start and end times, time intervals, or other key parameters, the data processing center 120 automatically generates a parameter setting information record and stores it in the data storage module 130. This record includes, but is not limited to, the operation time, operator identification, parameter values before and after modification, and the type of the current parameter change. The aforementioned records can serve as important evidence in subsequent maintenance operations, fault analysis, and responsibility apportionment processes, thereby further enhancing the reliability of system operation and the standardization of management.

In other embodiments, the data processing center 120 can also perform data interaction with a road traffic information system. When the towing vehicle travels to a specific road segment, the data processing center 120 can, based on the vehicle's geolocation data and after road segment matching and region determination, establish a communication connection with a road traffic management platform, a vehicle-road collaboration system (such as a roadside unit (RSU)), or a cloud service system, thereby acquiring road attribute information and maximum speed limit information for that road segment.

Specifically, after the data processing center 120 determines, based on real-time latitude and longitude data, that the vehicle has entered a preset road segment, it automatically reads and records the maximum allowable travel speed for that road segment and stores it as the target reference speed parameter for the road segment. During subsequent travel, the data processing center 120 continuously receives real-time speed data uploaded by the GPS module 111 and performs comparative analysis of the current speed against the maximum travel speed of the road segment.

When it is detected that the vehicle speed exceeds the maximum speed limit of the road segment, or when the speed remains close to the maximum speed limit for an extended period within a preset safety margin (for example, a first threshold below the maximum speed limit) and the duration reaches a set overspeed determination threshold, the data processing center 120 can generate a corresponding overspeed risk log or non-compliant usage log. The log can label and archive information such as the road segment identifier, occurrence time, duration, maximum overspeed value, and speed variation during the overspeed period, for use in subsequent operating record analysis and responsibility determination.

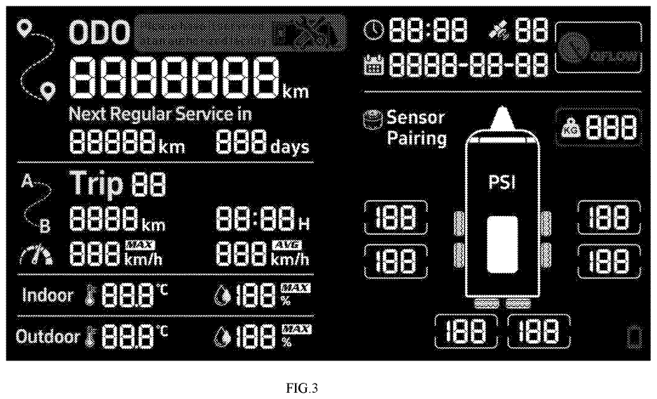

Please refer to FIGS. 1 and 3. The system further comprises a human-machine interaction module 140, through which a user can view key operating parameters within the current time period or a specified time period via an on-board terminal or a mobile terminal, including values such as vehicle speed, tire pressure and temperature, hitch load pressure (detected hitch weight), indoor and outdoor temperatures, as well as comparison results between these parameters and their respective safety-use specification thresholds. The human-machine interaction module 140 can include components such as a display screen 141, an indicator light 142, a buzzer 143, and button(s) 144. The interface can identify the current status of each parameter using different colors, icons, or text prompts—for example, by highlighting parameters exceeding safety ranges with conspicuous colors or warning icons—thereby enabling users, based on a full understanding of the travel trailer's current operating status and potential risks, to make autonomous judgments on whether to reduce speed, adjust operating conditions, take maintenance measures, or stop operation, so as to enhance safety and controllability during use and reduce disputes arising from information asymmetry.

It should be noted that each data viewing operation initiated by a user through an on-board terminal or mobile terminal is recorded by the data processing center 120 as a query log. The query log includes at least the viewing time, type of terminal initiating the query, and parameter categories viewed or corresponding road segment information, to provide objective and complete recorded evidence for subsequent tracing and analysis of user awareness and specific usage behaviors, thereby further perfecting the closed-loop management capability of the present invention in the “monitoring-alerting-querying-tracing” chain.

To further improve the safety and controllability of the travel trailer, in other optional embodiments, when the data processing center 120 determines that an overspeed risk or non-compliant usage behavior exists and preset alert conditions are met, it can, while recording the relevant log, trigger audiovisual alarms, interface pop-up prompts, or remote alert push notifications. For example, the data processing center 120 can control an on-board buzzer 143 and warning lights to issue audiovisual prompts and display conspicuous text or icon alerts on the on-board display screen 141; at the same time, through a wireless communication module, transmit alert information to a remote management platform or a user's mobile terminal. Upon receiving the alert, users or administrators can promptly become aware of the current risk status and take corresponding measures, thereby further enhancing the safety of travel trailer usage and the proactivity of management.

Please refer to FIGS. 1 and 2. In this embodiment, the data storage module 130 employs NAND flash storage technology and is configured to store driving logs and operating logs generated by the data processing center 120. The local storage can be flash memory, a solid-state drive, or an in-vehicle dedicated storage chip, with capacity configured according to system design requirements, to enable classified or unified storage of normal condition logs and abnormal condition logs during vehicle travel, facilitating subsequent queries, statistical analysis, and fault tracing.

In other embodiments, when the number of stored logs or the occupied storage space in the data storage module 130 reaches a preset upper limit, the system initiates a log migration and circular management mechanism. Specifically, the data processing center 120 can periodically or before each new log write detect the remaining available space in the data storage module 130; when the detection result indicates that the current storage space usage reaches or exceeds a preset space threshold, or the log count reaches a preset count threshold, the data processing center 120 triggers a log migration process.

In the log migration process, the data processing center 120 first selects the driving log with the earliest timestamp from the local storage as the object to be migrated. After selection, the data processing center 120 transmits this driving log to a remote server via a wireless communication network (such as 4G, 5G, or WiFi). Before transmission, the data processing center 120 can also perform compression processing on the log data to reduce data volume, encryption processing to enhance data transmission security, and generate a checksum (such as a checksum or hash value) for verifying data integrity at the receiving end.

Upon receiving the log data, the remote server first performs an integrity check on the received data; if the check passes, it classifies and stores the log according to vehicle identifier, time information, and log type, and returns a successful reception confirmation to the data processing center 120. Upon receiving the confirmation from the remote server, the data processing center 120 deletes the corresponding driving log record from the local storage to free up storage space. The aforementioned log migration process can be repeated as needed to gradually free up space in the data storage module 130, thereby ensuring that the local data storage module 130 always has sufficient capacity to store new driving logs and operating logs and avoiding situations where logs cannot be recorded due to insufficient storage space.

Through the above approach, the remote server can long-term centrally store vehicle driving and operating log data and enable retrieval and analysis based on vehicle identifier, time range, and log type, providing data support for subsequent historical travel trajectory backtracking, non-compliant behavior analysis, service life assessment, and after-sales service.

For example, when the travel trailer has traveled 1,000 km and the driving data stored in the data storage module 130 approaches the upper limit, upon detecting that storage space is about to be exhausted, the system automatically initiates a log migration program, uploads the earliest driving data to a remote server, deletes the locally stored log, and frees up space to ensure storage of new data. This operation does not affect data integrity and ensures seamless data preservation.

It should be noted that, when the network status is poor or the remote server is temporarily unreachable, if the data processing center 120 fails to obtain a reception confirmation while attempting to upload the earliest driving log, it can mark that log as “pending upload” and defer deletion of the local log. The system can, through scheduled tasks or upon detecting network recovery, automatically re-initiate a transmission request for the “pending upload” log; after the remote server successfully receives it and returns a confirmation, the corresponding local log record is deleted. Through the aforementioned retransmission and status management mechanism, the reliability and integrity of the driving log data upload process can be improved, minimizing data loss due to temporary network failures.

In other optional embodiments, the data processing center 120 and the data storage module 130 can be integrated and encapsulated into the same independent enclosure (hereinafter referred to as the “black box”). The black box is mounted on the travel trailer body via quick-plug electrical interfaces and mechanical mounting structures. When a user replaces the travel trailer, the operator can first disconnect the black box from the power supply, sensor module 110, and communication interfaces of the original travel trailer, remove the black box from the original travel trailer; subsequently, install the black box into the pre-reserved mounting location of the user's new travel trailer and complete the connection and fixation using the same type of quick-plug electrical interfaces and mechanical mounting structures. In this manner, there is no need to repeatedly configure a complete data processing and storage system on every travel trailer, which helps reduce production costs, simplify installation and commissioning processes, and reduce later maintenance workload.

After the black box is replaced and correctly connected to the sensor module 110, power supply, and communication network of the new travel trailer, an authorized engineer can establish a communication connection with the data processing center 120 inside the black box via a dedicated debugging interface or host computer software and reconfigure it. Specifically, the authorized engineer can sequentially adjust and input safety thresholds for various operating parameters, alert strategies, maintenance mileage or maintenance time setting values, etc., based on vehicle parameters of the new travel trailer such as total mass, tire specifications, suspension structure, allowable towing mass, and applicable road condition grades, so that the safety-use specifications preset in the data processing center 120 match the actual operating conditions of the new travel trailer. When necessary, calibration coefficients related to the new travel trailer can also be recalibrated to ensure the accuracy of subsequent data determination.

After completing the reset of vehicle parameters and safety thresholds, the system can perform a clear or initialization operation on the existing driving logs and operating logs in the data storage module 130. The data processing center 120 can, through internal control commands, batch delete or mark as invalid the log records in the storage area that are related to the old travel trailer, causing the driving records of the new travel trailer to restart counting from the moment the black box is installed and put into use, thereby avoiding intermingling of driving data between different vehicles, ensuring the accuracy, traceability, and effectiveness of statistical analysis of the log records, and also facilitating protection of the usage privacy of the user's previous travel trailer.

In other implementable embodiments, before performing log clearing, the data processing center 120 can also back up historical driving logs and operating logs to a remote server via wireless communication. During backup, the logs can be classified and uploaded according to vehicle identity identifier, time range, and log type, for use by the manufacturer or authorized service institutions in long-term data analysis and quality tracking. Upon completion of log backup and local initialization operations, the system can also automatically generate an equipment migration log recording information such as the time of the black box replacement operation, identity information of the original travel trailer, identity information of the new travel trailer, and identification of the engineer involved in the configuration, and store this migration log in the remote server or local data storage module 130, to provide evidence for subsequent equipment management, after-sales service, and responsibility apportionment.

Considering that the towed travel trailer itself lacks a power source and its power supply typically has multiple sources (such as towing vehicle power supply or travel trailer battery power supply), to ensure that the travel trailer intelligent safety management system experiences no power interruption risk across various usage scenarios such as towing travel and parked storage, the present embodiment provides a dual-power automatic switching system, detailed as follows:

The dual-power automatic switching system comprises a power input module, a power detection module, and intelligent switching control logic (along with its corresponding power isolation and switching circuits).

In this embodiment, the power input module is configured to connect at least two mutually independent power sources.

First, power from the towing vehicle is obtained through a standardized towing connector (such as a 7-pin or 13-pin plug) and is designated as the priority power source.

Second, power from the travel trailer's own battery and/or the travel trailer's power distribution system serves as the backup. When the towing vehicle is not connected, during prolonged parking, or when the towing vehicle power fails, the backup power provides continuous power supply to the travel trailer intelligent safety management system.

The power sources can also be extended to include other forms such as external mains power or photovoltaic inverter power, which are aggregated by the travel trailer's power distribution system and connected to the dual-power automatic switching system through the power input module.

In this embodiment, the power detection module continuously monitors the voltage status and availability of the two power paths. Specifically, the power detection module reads the voltage values of the towing vehicle power and the travel trailer's own power at preset sampling intervals and compares the detection results against a preset normal operating voltage range.

When it is detected that the towing vehicle power is present and its voltage is within the preset normal range, the travel trailer is determined to be in a towing travel state or to have towing power supply available, and the power detection module outputs a “towing vehicle power available” status signal to the intelligent switching control logic.

When it is detected that the towing vehicle power is unplugged, interrupted, or its voltage falls below a set threshold, the power detection module sends a power switching request signal to the intelligent switching control logic, indicating the need to switch from the towing vehicle power to the travel trailer's own power.

In this embodiment, the intelligent switching control logic controls the power isolation and switching circuit based on the power status information provided by the power detection module to achieve automatic, seamless switching between the two power paths. Specifically: when towing vehicle power connection is detected, the system power supply is automatically switched to the towing vehicle power as the priority power source; and when towing vehicle power unplugging, interruption, or voltage abnormality is detected, the system power supply is automatically seamlessly switched to the travel trailer's own power. At this point, starting from vehicle travel, the data processing center 120 can utilize the stable towing vehicle power to continuously record key data such as vehicle speed, initial tire pressure, detected hitch weight, and geolocation.

When the towing vehicle power is disconnected or exhibits voltage abnormality, after a very brief anti-bounce delay (to filter transient fluctuations and avoid false judgments), the intelligent switching control logic automatically switches the system load from the towing vehicle power to the travel trailer's own power supply and simultaneously provides electrical isolation between the towing vehicle power and the travel trailer's own power, ensuring that the travel trailer intelligent safety management system continues to operate stably under parking or temporary disconnection conditions.

For example, during travel trailer operation, if the towing vehicle power suddenly disconnects, causing a power outage, the power detection module detects that the towing vehicle power voltage is interrupted and below the set threshold, automatically triggering a switch to the travel trailer power supply. The system records this abnormal event in real time, generates a log marked “power abnormality interruption” indicating the fault type and duration, and stores the log for subsequent review and analysis by maintenance personnel.

It should be noted that, when normal connection of the towing vehicle power is detected, the towing vehicle power is preferentially used for system power supply, and based thereon, the vehicle is determined to be in a pre-departure or in-transit stage; when no towing vehicle power connection is detected or the towing vehicle power is disconnected, the system automatically switches to the travel trailer's own power supply, and based thereon, determines that the vehicle is in a post-decoupling or parking stage.

It should also be noted that the intelligent switching control logic can be implemented using relay arrays, solid-state power switches, or ideal diode OR-ing circuits to achieve electrical isolation and priority management between the two power paths, preventing reverse current flow between power sources. During the power switching process, the system power interruption time can be controlled at the millisecond level or shorter, far below the system power hold-up time, without causing controller power loss, reset, or loss of buffered data, thereby avoiding interruption of the data processing center 120's operation or of driving log and operating log recording, achieving continuity of data recording and forming a full-lifecycle data chain covering both towing travel and parking stages of the travel trailer.

In other embodiments, the dual-power automatic switching system can also integrate AC/DC overvoltage protection, undervoltage protection, overcurrent protection, and reverse polarity protection functions. When a serious abnormality is detected in the current power supply (for example, voltage exceeding the allowable range, excessive output current, or reverse polarity connection), the system can automatically switch to the other power path or cut off the load and enter a protection mode to avoid damage to the data processing center 120 and other electronic modules. When one power path completely fails or experiences prolonged power loss, the other power path can immediately take over the power supply to ensure continuous operation of the travel trailer intelligent safety management system.

During specific use of the present invention, based on receiving data from the sensor module 110 and generating operating logs and abnormal event logs, the data processing center 120 introduces a three-section recording scheme segmented by usage stages, namely: (1) pre-departure recording section; (2) in-transit recording section; and (3) post-towing vehicle decoupling or parking recording section.

The data processing center 120 organizes the aforementioned three types of records into a structured document format, with each record corresponding to one log entry, fields written sequentially in a preset order and separated by agreed delimiters, enabling the record data to be directly used for export, backup, and subsequent evidence analysis, thereby providing foundational data support for accident reconstruction assistance and responsibility determination described later.

The accident reconstruction assistance includes at least reconstruction of accident-related operating states, location of abnormal triggering processes, and backtracking of key log segments.

Specifically, when the dual-power automatic switching system detects that the main towing vehicle power is successfully connected through the hitch plug and the power voltage is within the normal operating range, the data processing center 120 automatically determines that the travel trailer has entered the “pre-departure recording section.”

At this point, the data processing center 120 initiates the pre-departure recording task and enters a static detection state:
when the GPS module 111 detects that the speed of the travel trailer or towing vehicle is 0 and this condition persists for a preset duration (for example, several seconds), the system remains in the pre-departure recording state; when the GPS module 111 first detects that the speed exceeds 0 and persists beyond a preset time threshold, the data processing center 120 determines that vehicle travel has begun, encapsulates the currently accumulated pre-departure detection data into one or more “pre-departure record logs,” and saves this batch of logs as initial evidence.

Within the pre-departure recording section, the data processing center 120 collects and records at least the following data fields:

Date information: obtained from a real-time clock module or GPS time information, written into the log record in a unified format such as “YYYY-MM-DD” to identify the natural date of the record.

Time information: obtained from a real-time clock module or GPS time information, written into the log record in a format such as “hh:mm:ss” to precisely locate the moment when the recording action occurs.

Current mileage information: the data processing center 120 obtains the cumulative driving mileage through integral calculation from the GPS module 111 or directly reads the current mileage value from an on-board odometer; this value serves as the “initial mileage” field in the pre-departure record for subsequent comparison with mileage data during travel, forming a complete trip evidence chain.

Maintenance status information: the data processing center 120, based on the maintenance management function, compares the cumulative driving mileage and cumulative usage time against preset maintenance thresholds; if maintenance is due or overdue, the “maintenance status” field in the log is marked as “maintenance alert triggered,” with further annotation of the trigger reason (mileage trigger, time trigger, or both simultaneous); if the thresholds have not been reached, the “maintenance status” field is marked as “normal” or “not due.”

Hitch weight data: obtained through manual operation of an independent tongue weight scale 115 by the user, performing one or more weighing operations within the pre-departure recording section to obtain the current hitch load pressure. The tongue weight scale 115 transmits the weighing results to the data processing center 120 via electrical connection or wireless communication connection (such as wired interface, Bluetooth, or WiFi). After receiving the tongue weight data, the data processing center 120 compares the pressure value against the preset safety range: if it exceeds the allowable range, an abnormality label such as “overload” or “underload” is added to the “detected hitch weight” field. At the same time, the data processing center 120 writes the tongue weight data uploaded by the tongue weight scale 115, along with its timestamp and vehicle identification information, into the pre-departure record log, and marks the current weighing status as “weighed.”

In certain implementations, when a user performs multiple tongue weight measurements before departure, the data processing center 120 can record all weighing data or only the most recent weighing data, with the specific strategy configurable at the factory. To remind the user to fulfill the weighing obligation, the data processing center 120 can also display the tongue weight measurement status on the pre-departure interface: when no valid weighing data uploaded by the tongue weight scale 115 has been received within the current pre-departure recording section, the tongue weight status is marked as “not weighed” and a prompt is displayed on the interface; when the GPS module 111 detects that the vehicle has begun traveling and triggers the “pre-departure record end and save condition,” if no weighing data from the tongue weight scale 115 was received during that period, the pre-departure record log explicitly records the tongue weight status field as “not weighed” or “user did not perform tongue weight weighing operation.”

In this way, even if the user does not perform tongue weight measurement, the system forms a “not weighed” record in the log, facilitating objective reconstruction, during accident analysis or dispute resolution, of whether the user fulfilled the tongue weight detection obligation.

Tire pressure data: tire pressure of each wheel is detected by tire pressure and temperature sensor(s) 112. Within the pre-departure recording section, the data processing center 120 requires all tire pressures to be within safety threshold ranges and records the tire pressure values of each wheel in the “tire pressure data” field. The user manual or instructions can stipulate that towing travel should only commence when the on-board terminal displays “tire pressure normal”; if any tire pressure is abnormal, the system adds a “tire pressure abnormality” label in the pre-departure record and can issue a maintenance prompt on the display terminal.

When the user begins traveling and the GPS module 111 detects that the speed exceeds 0, the data processing center 120 automatically determines that the travel trailer has entered the “in-transit recording section.” Within this section, in-transit recording primarily focuses on key recording and enhanced labeling of overspeed-related data. Specifically, the data processing center 120 can automatically obtain the maximum allowable speed of the current road segment based on road segment speed limit information provided by a road traffic information system; alternatively, manufacturer-authorized personnel can preset a set of fixed safety speed limit parameters in engineering mode.

When the GPS module 111 detects that the current speed reaches or exceeds the maximum allowable speed or the set safety speed limit, the data processing center 120 determines entry into the “in-transit overspeed recording state” and begins additional recording of overspeed-related operating parameters 116. During travel, the system does not need to perform high-density storage of every instantaneous speed but instead focuses on recording in “overspeed segment” units. For each time interval determined to involve overspeed or overspeed risk, the data processing center 120 records at least the following information:
within a particular overspeed segment, the maximum speed value occurring in that segment is counted and recorded as the “maximum speed” field; the time length from when the speed first exceeds the speed limit threshold until it returns to within the safe range; the date and time of the overspeed start and end moments; and, in combination with geolocation sensor data, the approximate latitude and longitude or road segment affiliation of the overspeed segment start and end points.

By recording in-transit overspeed information in the form of independent “overspeed segment logs,” this embodiment provides objective data basis after an accident occurs for determining whether prolonged overspeeding, frequent overspeeding, or other non-compliant usage behaviors existed; and can, in combination with the aforementioned maintenance status, tire pressure, and detected hitch weight records, analyze whether the vehicle was in a high-risk state of overload, abnormal tire pressure, or unsuitable road conditions prior to the accident. When a user views overspeed records through a terminal, the system synchronously generates a query log 145, making “whether the user was informed of the overspeed behavior” traceable and further perfecting the evidence chain required for responsibility determination.

After the travel trailer reaches a designated location, the dual-power automatic switching system continuously monitors the status of the main power source (towing vehicle power supply) and backup power source (travel trailer self-battery or campground external power). When it is detected that the towing vehicle power is unplugged or the voltage drops to a preset lower limit and the power input module automatically switches to the travel trailer backup power supply, the data processing center 120 determines that the travel trailer is in the “post-towing vehicle decoupling/parking state”; at this point, the system switches from travel recording mode to parking monitoring mode and initiates the data recording task for the “parking recording section.”

Within the parking recording section, the data processing center 120 invokes indoor and outdoor temperature and humidity sensor(s) 113 and a level attitude sensor to perform periodic or condition-triggered recording of the travel trailer's interior and exterior environmental status, using specific methods including but not limited to:

### Periodic Recording Method

A fixed time interval is set (such as every 10 minutes, 30 minutes, or 1 hour), and at each interval point, the system reads once the interior temperature, exterior temperature, and interior relative humidity, recording this data along with the current date and time. This method is suitable for uniform sampling of long-term parking environments, facilitating assessment of whether the travel trailer has been subjected to prolonged high-temperature exposure, severe cold, or high humidity.

### Threshold-Triggered Recording Method

Preset upper or lower threshold values for interior and exterior temperature and humidity, such as when the interior temperature exceeds a certain high-temperature threshold or the interior humidity remains in a high-humidity range for an extended period. When it is detected that the temperature or humidity first crosses the aforementioned threshold or remains exceeding the threshold for a certain duration, the data processing center 120 generates an “environmental abnormality event log” recording information such as the start and end times of the abnormality, maximum or minimum temperature/humidity values, etc. This method emphasizes extreme environmental events, facilitating tracing, after issues such as interior decoration aging, mildew, or equipment damage occur, of whether the travel trailer was subjected to prolonged adverse environments.

The aforementioned parking records are likewise stored in a structured document format, with parameters and determination results separated by delimiters for ease of user viewing and backend analysis. Through the parking recording section, the system continuously records the temperature and humidity environment of the travel trailer during parking, thereby providing objective evidence, when issues such as interior mildew, decoration material aging, or electrical component moisture damage occur later, of whether the travel trailer's long-term parking environment complied with usage specifications. When the environment reaches preset extreme thresholds (such as high temperature or severe cold), in addition to recording the log, the system can issue prompts to the user via an on-board terminal or mobile terminal, reminding the user to take corresponding protective measures (such as activating air conditioning, ventilation, or relocating the parking position); each time a user views parking environment records through a terminal, the data processing center 120 generates a corresponding query log 145, thereby proving the user's awareness of the travel trailer environmental status during parking.

Across the aforementioned three sections, the data processing center 120 uses a uniform log format, writing fields into a single text record in a fixed sequence and separating them with agreed delimiters. For example, a pre-departure record may sequentially include: date, time, current mileage, maintenance status, detected hitch weight, tire pressures for each wheel, and other status flags. Optionally, the system attaches to each record a timestamp, vehicle identity identifier, record type identifier (pre-departure/in-transit/parking), and checksum, and transmits and backs up between the local data storage module 130 and remote server via encryption and integrity verification mechanisms to ensure data consistency and non-tamperability during recording, transmission, storage, and retrieval, thereby enhancing the effectiveness and credibility of the data as evidence for accident analysis, fault tracing, and responsibility determination.

Through the aforementioned recording mechanism segmented by usage stages, the present invention not only achieves full-lifecycle safety status monitoring and traceable management of the travel trailer from pre-departure through in-transit to parking, but also synergizes with the aforementioned hardware modules and communication modules to provide a clear logical foundation and data support for functional expansions and application scenarios in subsequent embodiments.

In other embodiments, based on the recording in the three sections of pre-departure, in-transit, and post-towing vehicle decoupling or parking described above, the present invention can also monitor and record rapid acceleration and rapid deceleration behaviors of the travel trailer during travel. Specifically, within the in-transit recording section, the data processing center 120 combines outputs from the GPS module 111 and an acceleration detection sensor (such as a three-axis accelerometer or inertial measurement unit (IMU)) to identify short-term rapid acceleration or rapid deceleration conditions of the vehicle, and writes information such as event occurrence time, location, maximum acceleration, speed variation, and duration into operating logs and abnormal event logs. Frequent rapid acceleration and deceleration impose repeated and significant impact loads on the hitch and surrounding connection structures, potentially accelerating fatigue damage to ball hitch components, towing frames, and related welds and bolt connections, thereby affecting the service life of the connection structure and the entire vehicle. Through continuous monitoring and recording of the aforementioned behaviors, when connection structure loosening, deformation, or damage occurs, analysis can be performed in conjunction with corresponding driving conditions to provide objective evidence for determining whether the fault is related to long-term impoor driving behavior.

Within the post-towing vehicle decoupling or parking recording section, the present invention can also monitor and record the level attitude of the travel trailer. A level attitude sensor, such as an electronic level or tilt sensor, is provided on the travel trailer chassis or body structure to detect the pitch angle and roll angle of the travel trailer relative to the horizontal plane. During travel trailer parking periods, the data processing center 120 continuously acquires attitude data via periodic sampling or threshold triggering; when it is detected that the travel trailer has been parked for an extended period on a steeply sloped or significantly uneven surface, the corresponding attitude deviation angle, duration, and environmental parameters during that period are recorded as a parking attitude log or attitude abnormality event log. Long-term significantly uneven parking attitude causes uneven static stress on the frame, body, interior furniture, equipment mounting points, and similar components, readily leading to permanent deformation of local structures, loosening of connections, or interior cracking; through recording of the travel trailer level attitude, the present invention provides a traceable data foundation for subsequent analysis of whether structural damage, deformation, or similar issues are related to improper long-term parking attitude.

Through comprehensive monitoring and recording of rapid acceleration/deceleration behaviors and travel trailer level attitude, the present invention, building on the original three-section recording framework, further characterizes the actual stress conditions of the travel trailer connection structure and main body from both dynamic driving and static parking perspectives, rendering operating logs and abnormal event logs more complete and continuous, and providing more comprehensive and persuasive evidentiary support for assessing travel trailer service life, analyzing structural fault causes, and resolving quality disputes.

In summary, the above descriptions demonstrate that the present invention achieves the following technical effects: By sensing key parameters such as hitch weight, tire pressure, maintenance status, and temperature/humidity through multiple sensors, and continuously, normatively, and systematically recording the related data, an objective and complete operating data chain is formed, providing a reliable data basis for subsequent accident analysis, fault tracing, and responsibility determination.

1. A safety status monitoring and traceable management system for a travel trailer, comprising:
a sensor module configured to monitor a plurality of operating parameters of the travel trailer during use, the operating parameters comprising at least one parameter related to at least one of the following:
total driving mileage, maintenance status, vehicle speed, wheel status, hitch weight, temperature and humidity inside and outside the travel trailer, and level attitude of the travel trailer;
a data processing center in signal communication with the sensor module, with safety-use specification thresholds corresponding to the operating parameters pre-stored therein;
wherein the data processing center is configured to:
receive the operating parameters collected by the sensor module during operation of the travel trailer;
analyze the operating parameters in real time or periodically based on the safety-use specification thresholds to determine whether non-compliant usage behavior or operational abnormality exists;
generate an operating log record when no non-compliant usage behavior or operational abnormality is determined;
add an abnormality label to the corresponding operating log record and generate an abnormal event record when any operating parameter exceeds the corresponding safety-use specification threshold or non-compliant usage behavior is determined based on data change trends; and
a data storage module connected to the data processing center and configured to store the operating log records as well as the log records with abnormality labels and the abnormal event records,
wherein the log information is used, when an accident occurs, a failure arises, or a dispute needs to be resolved, to assist in accident reconstruction, including assisting in reconstructing accident-related operating states, locating abnormal triggering processes, tracing fault causes, determining responsibility, and analyzing user behavior.

2. The system of claim 1, wherein the sensor module comprises:
a GPS module configured to detect travel trailer driving speed, driving mileage, date, and time data;
tire pressure and temperature sensors respectively mounted on each wheel and configured to detect tire pressure and temperature of each wheel in real time;
temperature and humidity sensors respectively provided inside and outside the travel trailer and configured to detect temperature and humidity inside and outside the travel trailer and determine usage environments of facilities inside and outside the vehicle based thereon;
a level attitude sensor provided on the travel trailer and configured to detect pitch angle and roll angle of the travel trailer relative to horizontal plane to monitor the travel trailer's level attitude during parking.

3. The system of claim 2, wherein the sensor module further comprises:
a tongue weight scale configured to detect hitch weight through separate user operation, the tongue weight scale being in wired connection or wireless communication connection with the data processing center;
wherein after completing weighing, the tongue weight scale uploads the detected tongue weight data to the data processing center.

4. The system of claim 3, wherein the data processing center is further configured to, based on data collected from the sensor modules, introduce a three-section recording scheme segmented by usage stages, dividing the travel trailer usage process into pre-departure recording section, in-transit recording section, and post-towing vehicle decoupling or parking recording section;
in the pre-departure recording section, upon detecting towing vehicle power connected via hitch plug and vehicle speed at zero, collecting date, time, current mileage, maintenance status, hitch weighing data provided by the tongue weight scale, and tire pressures for each wheel, and generating pre-departure record logs;
in the in-transit recording section, upon detecting vehicle travel speed reaching or exceeding preset speed limit threshold, recording date and time corresponding to overspeed event and travel trailer speed data during overspeed;
in the post-towing vehicle decoupling or parking recording section, based on indoor/outdoor temperature and humidity sensors using periodic sampling or threshold triggering to record travel trailer parking environment temperature and humidity, and based on level attitude sensor to record travel trailer level attitude, and generating parking logs from the aforementioned recorded data.

5. The system of claim 1, wherein the data processing center has engineering mode with restricted access, manufacturer authorized personnel entering the engineering mode after identity verification to set system parameters.

6. The system of claim 5, wherein the engineering mode is configured to:
after manufacturer authorized personnel enter engineering mode through identity verification, receive maintenance reset command through setting interface and reset maintenance threshold counters, causing cumulative driving mileage and cumulative usage time to restart counting from reset moment to clear triggered maintenance reminder output, and update remaining maintenance mileage and remaining maintenance time based on preset maintenance mileage threshold and preset maintenance time threshold.

7. The system of claim 5, wherein the data processing center is further configured to execute maintenance management function comprising:
accumulating travel trailer driving mileage statistics based on vehicle speed related operating parameters or travel trailer mileage information;
accumulating travel trailer usage time statistics based on time information;
reminding travel trailer user via interaction interface when cumulative driving mileage reaches preset maintenance mileage threshold, or cumulative usage time reaches preset maintenance time threshold, or cumulative driving mileage and cumulative usage time both reach respective preset thresholds;
recording, before each travel trailer use after triggering maintenance reminder without timely maintenance execution, marking of abnormal usage due to failure to maintain, and saving in data storage module as data support for subsequent accident analysis, fault tracing, responsibility determination, and user behavior analysis;
storing maintenance reminder records as part of operating log records, as separate maintenance event records, or both simultaneously in the data storage module.

8. The system of claim 1, wherein the data storage module uses one or more of NAND flash memory, solid-state drive, or in-vehicle storage chip as local storage.

9. The system of claim 1, further comprising human-machine interaction module comprising at least one of display screen, indicator light, buzzer, and button, the data processing center configured to display to user via the human-machine interaction module key operating parameters including vehicle speed, tire pressure and temperature, hitch weight, travel trailer indoor/outdoor temperature and humidity.

10. The system of claim 1, further comprising dual-power automatic switching system comprising:
a power input module configured to connect to a towing vehicle power source and a travel trailer power source;
a power detection module configured to acquire voltage and current detection signals from towing vehicle power input terminal and travel trailer own power input terminal, and acquire power switching circuit path status feedback signal, to detect startup power source for data processing center and continuously determine during system operation the power path currently supplying data processing center; the power source information output by the power detection module used as basis for data recording by data processing center;
an intelligent switching control logic configured to: automatically switch system power supply to towing vehicle power as priority power upon detecting towing vehicle power connection;
automatically seamlessly switch system power supply to travel trailer own power upon detecting towing vehicle power unplugging, interruption, or voltage abnormality, to ensure data processing center and data storage module continuously operate maintaining data recording continuity;
wherein the intelligent switching control logic is configured to:
upon detecting normal towing vehicle power connection, preferentially use towing vehicle power for system power supply and determine vehicle in preparation for departure or in-transit stage accordingly; upon no towing vehicle power connection detected or towing vehicle power disconnection, automatically switch to travel trailer own power supply and determine vehicle in decoupled or parking stage accordingly.

11. The system of claim 1, wherein the data storage module is configured to initiate log migration to a remote server when stored log quantity or storage space reaches preset upper limit, compressing, encrypting, and integrity checking the logs prior to transmission, and deleting local logs after remote confirmation.

12. The system of claim 4, wherein in the pre-departure recording section, the data processing center marks tongue weight status as “not weighed” in the log if no valid data from tongue weight scale received before travel start.

13. The system of claim 10, further comprising overvoltage, undervoltage, overcurrent, and reverse polarity protection integrated in the dual-power automatic switching system.
